(19) United States
(12) Patent Application Publication
(10) Pub. No.: US 2009/0171970 A1
(43) Pub. Date: Jul. 2, 2009

(54) System and Method for Delivering Utility Usage Information and Other Content to a Digital Photo Frame

(76) Inventor: Robert A. Keefe, Honeoye Falls, NY (US)

Correspondence Address: CAPITAL LEGAL GROUP, LLC, 1100 River Bay Road, Annapolis, MD, 21409, US

(21) Appl. No.: 11/967,914

(22) Filed: Dec. 31, 2007

(51) Int. Cl. G06F 17/30

(52) U.S. Cl. 707/10; 707/E17.01

(57) ABSTRACT

A system and method for distributing content to a plurality of digital photo frames disposed in a plurality of customer premises is provided. In one embodiment, the method includes receiving a plurality of content and storing the content in memory. The method may include converting at least some of the content from a first format to a second format suitable for display by a digital photo frame and transmitting at least some of the content via the Internet to each of the plurality of digital photo frames for display. The content may include photos, emails, text messages, faxes, utility data, and/or other content. The method may also include storing information of a user in association with each of the plurality of digital photo frames, storing content configuration information in memory for each user, and selecting the content for transmission based on the content configuration information of the user associated with each digital photo frame.

### FIELD OF THE INVENTION

The present invention generally relates to digital photo frames, power line communication systems, and systems and methods for delivering information content to consumers, and more particularly to systems and methods for delivering utility information, photos and other content to a digital photo frame.

### BACKGROUND OF THE INVENTION

Residential building and other structures typically receive utility services, such as electricity, water and gas. Utility meters are provided to determine the amount of electricity, water, gas or other utility being consumed at the premises. These meters usually are located outside the building where a utility company employee can readily read the meter. Because the meters are outside, it is typically not convenient for the consumer to read meter. In addition, many consumers have difficulty reading a utility meter. Accordingly, other than from information in the monthly or bimonthly utility bill, the typical consumer does not know the amount or the cost of the electricity, water or gas that has been consumed. Even if such utility information (e.g., the quantity of the utility consumed and/or the cost of the utility consumed since the previous bill) was available to a consumer via a computer, for various reasons most consumers would not likely routinely retrieve the information.

It would be of benefit to a consumer, and to society, if utility information were more readily accessible or more frequently presented to the consumer. Such information could help the consumer regulate their consumption, and in particular, motivate and assist the consumer in finding effective ways for reducing consumption. Accordingly, there is a need for a convenient non-intrusive manner of providing utility information to consumers.

Photo frames for displaying images are well known. Typically, a photo frame is used to display a photograph, painting or other art-like creation, and may be free standing or hung on a wall. The present invention provides systems and methods for delivering utility information, image content and other content to a digital photo frame.

### SUMMARY OF THE INVENTION

The present invention provides a system and method for distributing content to a plurality of digital photo frames disposed in a plurality of customer premises. In one embodiment, the method includes receiving a plurality of content and storing the content in memory. The method may include converting at least some of the content from a first format to a second format suitable for display by a digital photo frame and transmitting at least some of the content via the Internet to each of the plurality of digital photo frames for display. The content may include photos, emails, text messages, faxes, utility data, and/or other content. The method may also include storing information of a user in association with each of the plurality of digital photo frames, storing content configuration information in memory for each user, and selecting the content for transmission based on the content configuration information of the user associated with each digital photo frame.

The invention will be better understood by reference to the following detailed description taken in conjunction with the accompanying drawings.

### BRIEF DESCRIPTION OF THE DRAWINGS

The invention is further described in the detailed description that follows, by reference to the noted drawings by way of non-limiting illustrative embodiments of the invention, in which like reference numerals represent similar parts throughout the drawings. As should be understood, however, the invention is not limited to the precise arrangements and instrumentalities shown. In the drawings:

FIG. 1 is a block diagram of an example embodiment of a digital photo frame suitable for use in some embodiments of the present invention;

FIG. 2 illustrates an example information content delivery environment, according to an example embodiment of the present invention;

FIG. 3 illustrates various configurations for the residential portion of a content delivery environment, according to example embodiments of the present invention;

FIG. 4 illustrates a configuration of a residential portion of a content delivery environment, according to another example embodiment of the present invention;

FIG. 5 illustrates a block diagram of a system for delivering content to a plurality of digital photo frames, according to an example embodiment of the present invention;

FIG. 6 is a flow chart of a user interface process, according to an example embodiment of the present invention;

FIG. 7 is a flow chart of a display manager process, according to an example embodiment of the present invention; and

FIG. 8 is a diagram of an example embodiment of a multi-media power line modem device according to an example embodiment of the present invention.

### DETAILED DESCRIPTION OF ILLUSTRATIVE EMBODIMENTS

In the following description, for purposes of explanation and not limitation, specific details are set forth, such as particular networks, communication systems, computers, terminals, devices, components, techniques, data and network protocols, power line communication systems (PLCSs), servers, photo frames, software products and systems, enterprise applications, operating systems, development interfaces, hardware, etc. in order to provide a thorough understanding of the present invention.

However, it will be apparent to one skilled in the art that the present invention may be practiced in other embodiments that depart from these specific details. Detailed descriptions of well-known networks, communication systems, computers, terminals, devices, PLCSs, components, servers, photo frames, techniques, data and network protocols, software products and systems, operating systems, development interfaces, and hardware are omitted so as not to obscure the description of the present invention.

Photo frames for displaying images are well known. A digital photo frame includes the frame and support components of the conventional picture frame, while also including a display device. For example, a digital photo frame may be hung on a wall or be free standing (e.g., set on an end table). Information may be received from the internet, stored in memory, and then displayed on a flat panel display component of the digital photo frame. One distinction of a digital photo frame over a conventional computing device, such as a personal computer (e.g., laptop, desktop, PDA, notebook, etc.), is that such computing devices include and execute user applications. More specifically, personal computers typically include an operating system (e.g., Windows®) on which one or more user applications execute. Such user applications may include, for example, word processors (e.g., Word®), spread sheets (e.g., Excel®), databases (e.g., Access®), development software, graphics software (e.g., Visio®), and other applications that receive data from, and process data for, the user. Further, while personal computers typically include a keyboard and pointing device (e.g., a mouse), digital photo frames typically include minimal user input components. Typically, when using a digital photo frame the user only selects one of a plurality of transitions modes and other characteristics that control the presentation of the digital images. In contrast, nearly any type of information may be inputted by the user of a personal computer (depending on the user applications present) to allow processing of data. Additionally, because digital photo frames are meant to mimic a conventional photo frame, they are typically aesthetically pleasing (in contrast to most computers) and sized to placed on a table or hung on a wall.

According to an example embodiment, a digital photo frame is coupled to the internet to receive utility information (e.g., electricity, gas, water, etc.) and other content. The content is received via the internet, stored in memory, and then displayed by the digital photo frame.

According to an example embodiment of the present invention, a plurality of members may have an account with a service provider. The service provider may have a server (a computer system) with a directory for each account member. In addition, a content display manager application may run on the server to configure member information and deliver content over the internet to each member's digital photo frame. Content from various sources may be uploaded to the member's directory. The member, other authorized users, a utility company and other third parties may upload various types of information to the member's directory. Examples of third parties may include email providers, RSS feed providers, and news feed providers. Examples of content may include, but is not limited to, utility information (e.g., utility consumption since the last bill, current accumulated cost since the last bill, projected cost at the end of the current billing period, price per unit of consumption (e.g., cost per kwh) at present time, cost per hour at the present time to consumer, pricing signals (an to alert the consumer that the cost of power is being changed—received in substantially real time; could be a green, red or yellow light to indicate cost of power), and shed events (the removal or connection of one or more power consuming devices from the consumers home power distribution system done via an automated load control system), digital photos, graphics, animations, advertisements, safety alerts, appointment and reminder data, fax messages, text messages, emails, news feeds, and RSS feeds. In some embodiments an audio output device also may be included with (connected to or integrated with) the digital photo frame. In such case, audio content also may be transmitted to the digital photo frame, such as voice mail messages, audio advertisements, and/or audio feeds (e.g., an internet radio station). In some embodiments, video capability also may be included allowing the digital photo frame to display video content (e.g., a live video feed or from YouTube.com® or other third party).

In some embodiments, the digital photo frame may permit minimal user input. For example, an on-off switch may be included. One or more buttons also may be included, such as to reset the digital photo frame or to select among one or more preprogrammed content display configurations. In such an embodiment, multiple configurations may be downloaded to the digital photo frame. The active configuration then may be selected by user input.

For more extensive control, members may login to their account online via a web interface using a computing device. While logged in, the member may select the information content to be displayed on the digital photo frame. For example, the member may subscribe or unsubscribe to various third party services. The member may create a slide show of digital photos. The member may access a calendar program, requests alerts for appointments, and set other reminders. In one embodiment, a member may configure a video feed, such as from their grandchild's room across the country. In particular, the member may create one or more information content configurations to be downloaded to the digital photo frame. The configuration information is stored on the server of the service provider.

### Digital Photo Frame

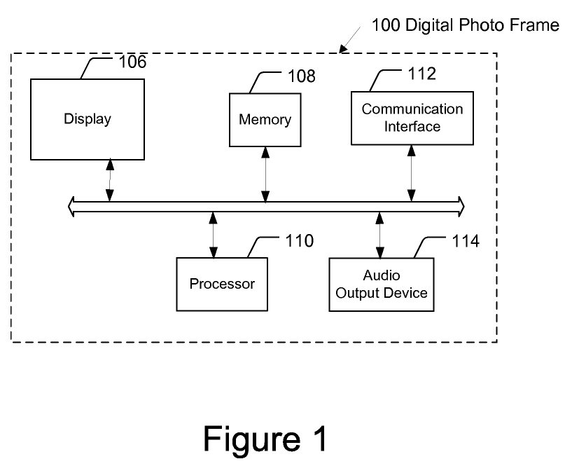

The As illustrated in FIG. 1, the digital photo frame 100 electronics may include a display 106, memory 108, a processor 110, an audio output device 114, and a communication interface 112. The display 106 may be a liquid crystal display, plasma display or other volatile or static flat panel display. Memory 108 may include volatile memory and non-volatile memory. The processor 110 manages the storage, retrieval and display of content so as to deliver content to the display 106 for viewing. Content may be received via the communication interface 112 and stored in memory.

One or more predefined information content configurations also may be received and stored in memory 108. The processor 110 may access a predefined content configuration to determine which data to supply to the display 106, and at what time (and for what duration) the content is to be displayed. In addition, in some embodiments the processor 110 may determine where on the display panel certain types of content are to be displayed. For example a news feed, an RSS feed or utility information may periodically be displayed in banner format across the top, bottom, left or right portion of the display.

In some embodiments, the digital photo frame 100 may include one or more buttons or switches that allow the user to provide user inputs to the processor 110. In an example embodiment, each one of multiple buttons may be assigned to a predefined content configuration. In another embodiment, a single button may be used to cycle through and select from among various predefined information content configurations.

As discussed, some embodiments of the digital photo frame 100 also may include an audio output device 114, such as a speaker. Audio content also may be received at the communication interface 112, stored in memory 108 and subsequently (or immediately) audibly produced by the audio output device 114. For example, voice mail messages, audio advertisements and other messages may be stored in memory 108. In some embodiments, an audio feed may be implemented in which audio content, such as from an internet radio station, is received via the Internet and routed by the processor 110 to the audio output device 114.

### Content Delivery Environment

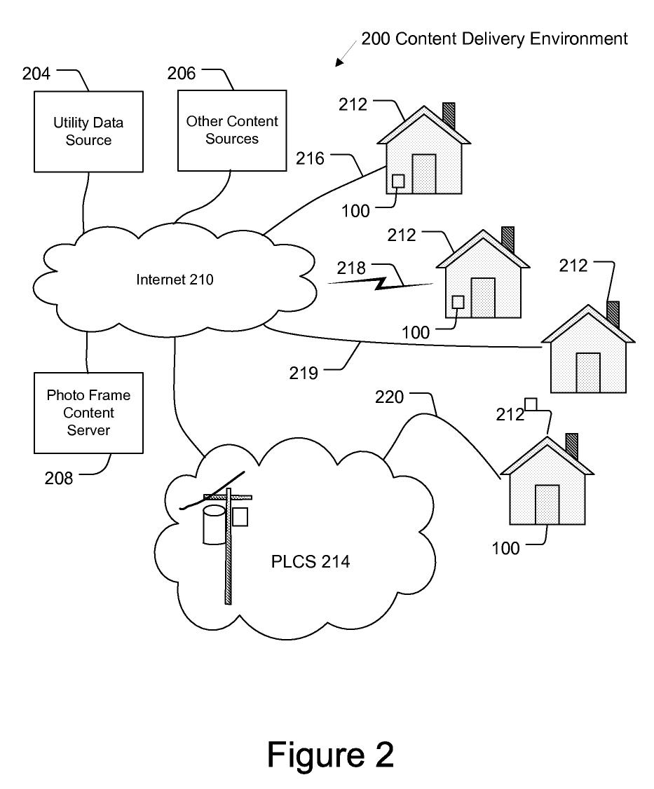

FIG. 2 shows a example content delivery environment 200 for delivering content to a plurality of digital photo frames 100. Information from a utility data source 204 and other content sources 206 may be communicated to a photo frame content server 208 via the internet 210. Content may be transmitted from the content server 208 to the plurality of digital photo frames 100 located at a plurality of customer premises 212. There are various media that may be used to deliver content to the members' premises, including wired and wireless media. In one embodiment, the communication path from the content server 208 to customer premises 212 may include a power line communication system (PLCS) 214, (which may comprise a broadband over power line (BPL) system), in which data is communicated over one or more power lines. Alternately, or in addition, in some embodiments the communication path may include a fiber optic communication system 219, another cable system (e.g., DSL, coax cable system) 216, a wireless communication system 218 (all shown schematically), or some combination thereof.

In an example embodiment, broadband communications from one portion of the internet may enter into the PLCS 214. The PLCS 214 may deliver broadband over power line services to various premises 212 including content for targeted digital photo frames 100. A PLCS communication device may include or connect to a point of presence of the internet, communicate internet data, and transmit communications over medium voltage (MV) and/or low voltage power lines (either of which may be underground or overhead power lines) to a neighborhood, city, or other region. Detailed descriptions of the components, features, and power line communication devices of an example PLCS are provided in U.S. patent application Ser. No. 11/423,206 filed on Jun. 9, 2006 entitled, “Power Line Communication Device and Method,” which is hereby incorporated herein by reference in its entirety. A detailed description of another example PLCS, its components and features is provided in U.S. patent application Ser. No. 10/973,493 filed Oct. 26, 2004, entitled “Power Line Communications System and Method of Operating the Same,” which also is hereby incorporated by reference in its entirety.

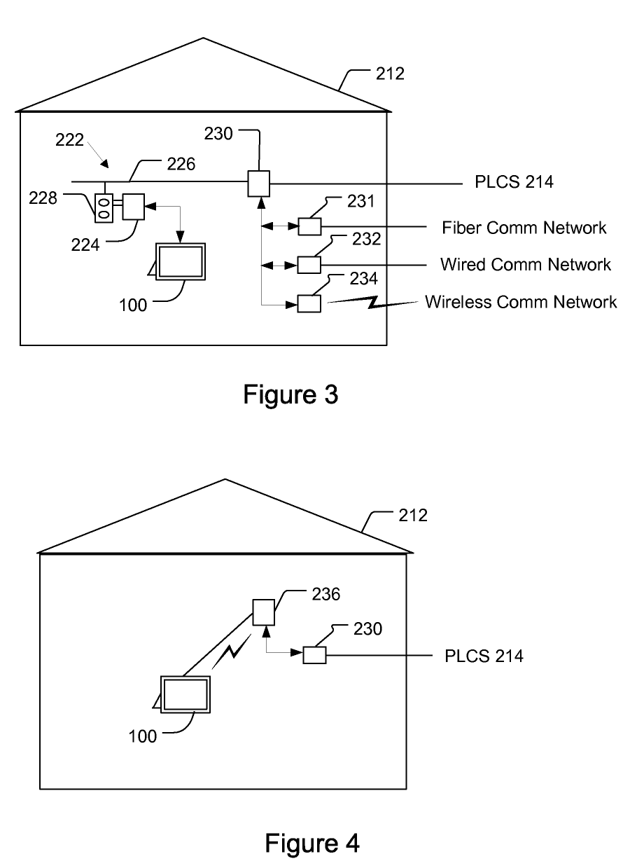

At each premises 212, received content is delivered to the digital photo frame 100 in the customer premises 212. FIG. 3 shows an embodiment in which the digital photo frame 100 is coupled to an internal low voltage power line 226, which in some instances may be used to form an in-home residential power line network 222. A power line network 222 may include two or more power line modems 224 coupled to a low voltage power line 226 within a building or other structure, such as customer premises 212. One protocol for communicating within a building over an LV power line is the HomePlug (e.g., 1.0, A/V, or Turbo) standard of the HomePlug® Alliance. The digital photo frame 100 may include a power line modem 224 as part of its communication interface 112, or, alternately, may be coupled to a power line modem 224 via its interface 112. In either case, the power line modem 224 plugs into a power outlet 228 to communicate over the low voltage power lines 226. In one example, the communication interface 112 may comprise a power line modem 224 and the residential power line network 222 is coupled to the PLCS 214 via a router 230.

In another embodiment, the residential power line network 222 may be coupled a fiber optic network via a fiber optic transceiver/router 231, a wired network via a cable modem/router 232 (or DSL modem/router), or a wireless network via a wireless modem/router 234.

FIG. 4 shows an embodiment in which the digital photo frame 100 communicates via a non-power line wired or a wireless medium within the premises 212. For example, the digital photo frame 100 may communicate wirelessly to a modem 236, which in turn communicates with an external communication network, such as a fiber, coax, DSL, wireless, or BPL network. In another embodiment, the digital photo frame 100 is coupled to the modem 236 using a wired interface such as by a twisted pair wire, Ethernet, coaxial cable, or another coupling wire. Modem 236 may include or be coupled to another modem suitable for communicating with the external network. In one embodiment modem 236 communicates with a power line modem 230, which in turn is coupled to the PLCS 214.

It is worth noting that the present invention can used to distribute content (photos, alerts, etc.) to consumers even though the consumers do not pay for internet access. For example, by plugging a digital photo frame into the internal low voltage power lines 226 of the customer premises 212 via a power line modem 224, the system can deliver content to the photo frame 100 via a PLCS (and similarly with a wireless network).

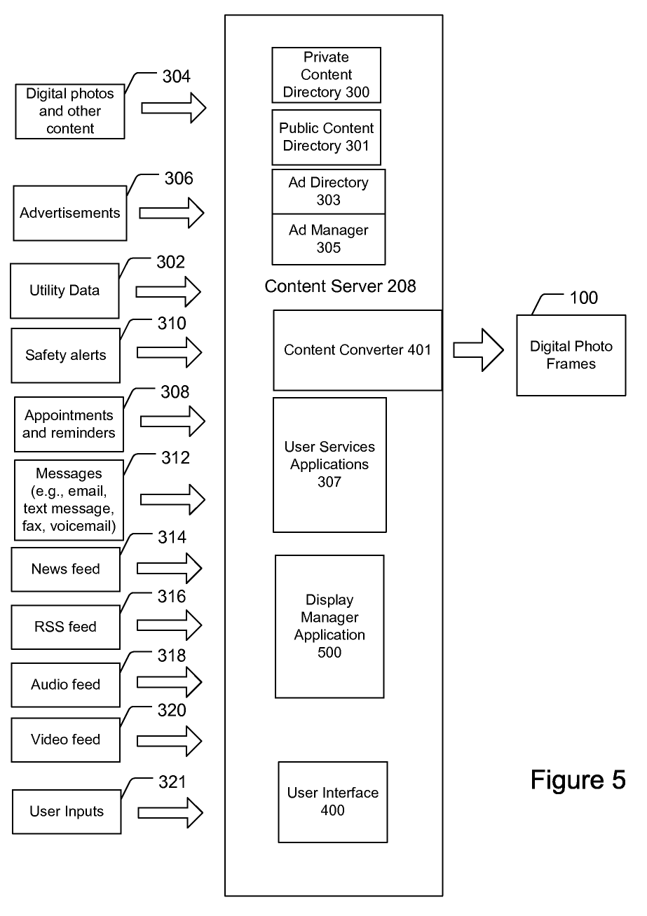

FIG. 5 illustrates the flow of data for an example system that includes a content server 208 for distributing content to a plurality of digital photo frames 100. Various types of content may be transmitted to and stored on the content server 208. Content as used herein may include any of digital photos, audio content, video content (that may have an audio portion), message content (such as those described herein), and any other content that can be presented (either visually and/or audibly) by the photo frames 100.

As discussed, each member may have an associated private content directory 300 to which the member controls access. More specifically, each member controls who may upload content 304 to the directory 300 and who may receive content from the directory 300. For example, a member may allow family members who live anywhere in the world to receive content from, and/or upload content 304 to, the private content directory 300. Thus, the member or another authorized user or some third party provider may upload content 304 to the private content directory 300. The content server 208 also may include a public content directory 301, to which the general public may have access. Depending on the embodiment, access to the public directory 301 may be limited to downloading content from the public directory 301 or may include both uploading content 304 to, and downloading content from, the public directory 301. The public content directory 301 may include themed sub-directories that include content of different categories. For example, each sub-directory may include content related to a particular artist (e.g., Van Goh, Andy Warhol, Ansel Adams, Frank Sinatra (audio), etc.), genre (e.g., renaissance), financial category, location (e.g., Hawaii, tropical, arctic, beach, etc.), season, sport, interest (e.g., aircraft, boating, sailing, skiing, fishing, hunting, flowers, animals, dogs, cats, gardening, dancing,), or other category. Depending on the embodiment, members of the public may be permitted access to upload content into some, or all, of the sub-directories.

Advertisements 306 may be uploaded to the advertising directory 303. The ad manager 305 may control the selection and distribution of advertisements in the ad directory 303 to the photo frames 100 of the plurality of members according to an advertising business model. Specifically, the ad manager 305 may select ads to be sent to each photo frame 100 based on one or more of (1) the location (e.g., address of member) of the photo frame (e.g., to thereby select ads for local venders), (2) information about the member (e.g., age, sex, interests, profession, political affiliation, etc.), (3) information about the member's family (e.g., number of persons in family, number of children, age of children, sex of children, type of pets, etc.), (4) ad selections of the member (e.g., the member may supply information of one or more types of desired advertisements), (5) an advertising price (e.g., a bid) offered by the advertiser; and/or (5) other factors considered selecting for ads well-known in the art.

Utility data 302 may be transmitted from the utility data source 204 to the content server 208 and communicated to the photo frames 100 in substantially real time or may be stored in the private content directory 300 for transmission to the photo frame(s) at a later time. As discussed, the utility data source 204 may be a utility company's server, a utility meter having a transmit capability or some other computing device or network capable of storing and communicating utility data. Typically, the raw consumption data (e.g., from a meter) from which the displayed utility data (e.g., cost) is derived, will be transmitted from an electronic utility meter in substantially real-time (e.g., daily, hourly, etc.) to a remote computer (e.g., operated by the utility company) for processing and transmission to the content server 208.

The utility data may be displayed as a ticker (banner) across the bottom of the display continuously, intermittently or over the entire display periodically (e.g., every ten minutes for thirty seconds between photos). As discussed, the displayed utility content may include one or more of (1) the quantity of the utility consumed since the most previous bill (e.g., watts), (2) the accumulated cost since the last bill (e.g., dollars), (3) the projected cost at the end of current billing cycle, (4) the cost per unit of consumption at the present time (e.g., cost per kwh, which allows the member to determine if they are being billed at peak or off peak rates), (4) the cost per hour (or day or week) for the last hour or averaged for the billing period, (5) or some other utility metric. In addition, the utility data may include an indication (red light or green light) that indicates whether power is currently being delivered under peak (higher) rates or under off-peak (lower) rates.

In addition, safety alerts 310 may be transmitted from a plurality of sources and communicated in substantially real time to the plurality of photo frames 100. Other alerts (e.g., weather, traffic, etc.) may be less urgent may be stored in the private content directory 300 to be rotated in along with other content.

The content server 208 may implement a calendar or other scheduling and reminder application implemented via a user services application 307. In such an embodiment, the member may enable and supply information to initiate the application 307 via the internet by using the user interface 400 (which may comprise a web interface). Thus, the member may log on to the content server 208 via the user interface 400 to set appointments and/or reminders 308 such as, for example, reminders of family member birthdays, anniversaries, and the like. Alternately, the reminders and appointments 308 may comprise data files received (e.g., via a synchronization process) from an Internet based calendar application such as those available from Google® and Microsoft® (e.g., Windows Live Hotmail®) or a client based calendar application such as Outlook® or Outlook Express® (e.g., wherein the data is uploaded from the member's computer). Based on the appointment and reminder data 308, the user services application 307 determines when a reminder should be sent to each photo frame 100 for display. For example, in one embodiment each morning the content server 208 transmits to each member's photo frame 100 content describing all the appointments and reminders for the day for the member.

Various messages 312 also may be supplied to the user services applications 307 including, but not limited to, emails, text messages, faxes, voice mails, etc. For example, the member may elect to have his/her email service provider forward emails to a unique email address at the content server 208 that is associated with the member. Thus, the member may control which emails to forward to the user services application 307 to thereby control which emails get to his/her photo frame 100. Alternately, the user services application 307 may include an email client that retrieves emails of the member from the email servers that serve the member's email addresses. Voice mails may be converted to text and also sent to the photo frames 100 or may be communicated as audio content and audibly produced by the photo frames 100. Similarly, faxes may be converted to an image and transmitted to the photo frames 100.

Similarly, the content server 208 may receive an audio feed 318, video feed 320, RSS feed 316, news feed 314 and/or other content feed (e.g., sports feed, financial feed, etc.) that is distributed to the photo frames 100 of the members who elect to receive them. For example, a live video feed 320 may be received from a first member and distributed by the content server 208, which streams the content to the photo frames 100 of one or more other members (e.g., who may be family members of the first member). Some types of content may be stored and distributed to the appropriate members while others (e.g., news feed, RSS feed, audio feed, video feed), instead, may be forwarded or distributed directly without long term storage.

A display manager application 500 may reside at the content server 208 and control the uploading or distribution of content. Data may be uploaded (received and stored) in the content directories 300 of respective members. The display manager application 500 also may control the transmission of content to the digital photo frames 100 of the respective members. Various parameters may be controlled including, but not limited to, what content is selected to be transmitted for display, when selected content is displayed (e.g., what time of day, week, month, year), how often selected content is displayed, how selected content is displayed (e.g., in a full screen, in a partitioned or split screen, in a ticker), how long content remains in a display list, how long each piece of content of a display list is displayed, and/or other parameters. Many of these parameters may be controlled (or influenced) by input from the member associated with the photo frame 100 as will be discussed below.

A user interface application 400 also may reside on the content server 208. The user interface application 400 allows a member to log in to their account and configure content in a manner consistent with a given service plan. In particular, some plans (e.g., for which the member pays a monthly fee) may allow a member to receive content without advertising content and other plans (e.g., that are free or discounted) require the member to receive advertising content interspersed with non-advertising content. After logging in, members may configure appointments, reminders, messages (e.g., reception of one or more of email, voice mail, text messages, fax, etc.), select public sub-directories, identify other authorized users, select advertisement categories, provide member information (e.g., age, address, hobbies, profession, etc.), upload content, select the type of alerts for display, configure the display of utility data, and other content configurations. For example, the member may select one or more internet radio stations to be used as an audio feed. The member also may select one or more internet video channels (e.g., a YouTube® video channel or domain channel (e.g., NFL.com)) to be used as a video feed. The member may also configure the type and frequency of the utility data to be displayed. In some embodiments, a member selects several content configurations. In addition, the user interface application 400 may include a scheduling application that allows a member to schedule different content configurations to be active at different times of the day, week, month or year.

Many photo frames 100 can only display images in a few format types (e.g., gif, jpg, etc.). Thus, some photo frames would not be able to display an ASCII message (e.g., a safety alert or email). In this embodiment, the content may be uploaded to the server 208 in any of a plurality of formats. Thus, the content server 208 includes a content converter 401 that converts the uploaded content from its native format (e.g., pdf, ASCII, etc.) to a display format (e.g., jpg, gif, etc.) that can be displayed by the photo frames 100. The converted content is subsequently pushed to the photo frames 100. Depending on the embodiment, the uploaded content may be converted to the display format (1) soon after being uploaded (e.g., for storage in a directory); (2) just prior to being pushed to a photo frame 100 (e.g., after being retrieved from a directory); or (3) depending on the type of content and/or other factors either (1) or (2).

Consequently, in one example embodiment the content server 208 pushes (transmits without receiving a request) display parameters and content to the photo frame(s) 100 of each member based on the member configurations, server configurations, content stored on the server 208, selected live feeds, etc., for sequential (or if partitions are used, concurrent) display according to the display parameters. The pushed content may be stored in the photo frames 100 as a display list until new content is received from the server 208 wherein the frame 100 continually and sequentially displays the content elements of the display list.

### Method for Delivering Information Content

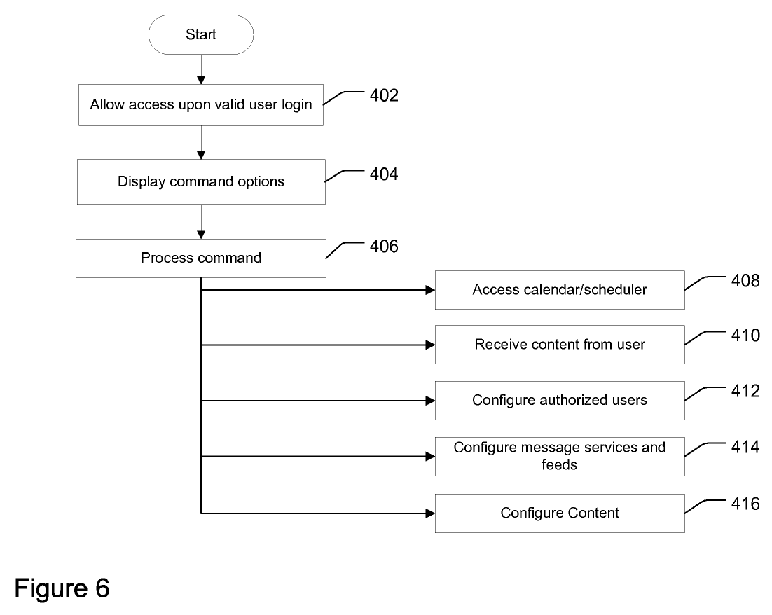

FIG. 6 illustrates processes of an example embodiment of the user interface application 400, which may be executed by the content server 208. A member logs in to the content server 208 at step 402. The member may login using any computing device having access to the internet and being capable of receiving user inputs (e.g., via voice or from a keypad, keyboard, touchpad or pointing device). At step 404, a command screen is displayed. The interface (e.g., an HTML page) may include various command options which allow the member to configure his or her service. A member may select one or more commands. The selected commands are processed at step 406, which, for example, may comprise providing additional web interfaces (e.g., HTML screens) that allow the member to enter additional data related to the selected commands. Depending on which commands are selected, one or more of steps 408-416 may be executed.

As one example, at step 408 the member may be given access to various calendar and scheduling options. The member may provide information regarding one or more appointments and request that the appointment information and/or reminders of the appointment be included among information to be communicated to, and displayed by, the digital photo frame 100. In addition, the member may set general reminders (e.g., birthdays, anniversaries), notes and messages to be displayed. In some embodiments, the member can set alarms, such as to receive an audio alarm sound that plays at a selected time (to thereby function as an alarm clock each morning).

As another example, a member may upload content such as digital photos, videos, other images, and audio to the server 208 at step 410 and indicate the directory (public or private) for the uploaded content. In addition, the member may establish a connection between a video cam in the member's residence and the content server 208 to provide a live video feed to the content server 208. The received content may received from the member and stored in the member's private directory 300 or the public directory 301 (e.g., a subdirectory therein).

At step 412 a member may configure authorized users, which may comprise creating (or identifying or enabling), editing, and deleting (or disabling) the authorized users and their privileges. Authorized users are other persons (members or non-members) who are granted access to all or portions of the member's private directory 300 (which may include a live video feed from the member's residence). The authorized user may then (using the interface) elect to receive any content in the private directory to which the member has granted the authorized user access.

At step 414 a member may configure the message services and content feeds. In this example embodiment, the member may select, subscribe, edit, and delete one or more message services and one or more content feeds. For example, for digital photo frame embodiments having an audio output, the member may configure an audio feed by selecting one or more desired internet radio station. As another example, a member may configure a video feed from a video cam coupled to the internet. For example, a member may elect to receive a video feed from a camera located in the next room (to thereby function as a child monitoring device), a camera directed to the member's front door or driveway (to thereby function as part of a security system), or a camera across town or across the country (e.g., such as to view a family member, relative, or friend). In one example embodiment, a video cam at the member's home is installed that includes a motion detector so that the camera begins transmitting a video feed only after detecting motion at, for example, the member's front door. The video feed may be received at the content server 208 and transmitted immediately to the member's photo frame 100 for immediate display with an audible alert.

A member also may elect to receive content from a third party service. For example, a member may subscribe to an RSS feed service, a news feed service, and a safety or weather alert service (fire, biohazard, earth quake, tornado, storm warning). Also, the member may configure his or her message services. For example, the member may select and configure the receipt of one or more of text messages, faxes, emails and voice messages. The configuration may allow the member to set up rules (similar to those available in common email client applications) to receive at the photo display all emails, emails transmitted from select email addresses, emails from select domains, emails that have certain text in the subject or body, etc. Similar rules may be used by the member to identify faxes, text messages, and voice mails to be sent to the photo frame 100.

Various third party services may supply content to the server 208, which in turns distributes the content to one or more digital photo frames 100 whose associated member has elected to receive the content. Thus, the content server 100 associates one or more photo frames with each member in memory. Each photo frame 100 may be identified by its media access control (MAC) address, IP address, serial number, or other substantially unique identifier. Each member may be identified by an email address, social security number, customer number, or other substantially unique identifier.

The user interface application 400 may enable the member to configure the content to be transmitted to the digital photo frame 100 at step 416. Thus, the member may select content stored on the server 208 to be transmitted to and displayed by the photo frame 100. A content configuration may comprise all the content stored in a member's private content directory 300. For example, by changing the content of the directory 310, the configuration is thereby changed. In another embodiment, selections may be made from among the content stored in the content directory 300. For example, the member may select a subset of the photos stored in the directory 300 to be displayed as a slide show. In addition, the member may select one or more sub-directories of content from the public directory 301. Finally, if authorized, the member may select content from one or more other members' private directories. The member may also configure what, when, and how utility content is displayed on the photo frame 100.

The member also may configure how the content is presented (e.g., displayed) by the photo frame 100. For example, the member may configure a news feed or utility data to be displayed as a banner across the bottom of the digital photo frame 100 periodically. In a sophisticated embodiment, the member may be able to apportion areas of the digital photo frame to display different information content (partitions). Further, the member may schedule specific content (e.g., groups of photos) to be displayed repeatedly at given times or intervals. In some embodiments, the member may be permitted to create and save multiple configurations and schedule the various configurations for various times.

In summary, among other things the user interface 400 allows the member to supply information to control various parameters including, but not limited to, what content is selected for displayed, when selected content is displayed (e.g., what time of day, week, month, year), how often selected content is displayed, how selected content is displayed (e.g., in a full screen, in a partitioned or split screen, in a banner), how long content remains in a display list, how long each content element of a display list is displayed, and other parameters. The information received via the user interface 400 is stored in memory of the content server 208 and used by the display manager 500 to control the distribution and display of content.

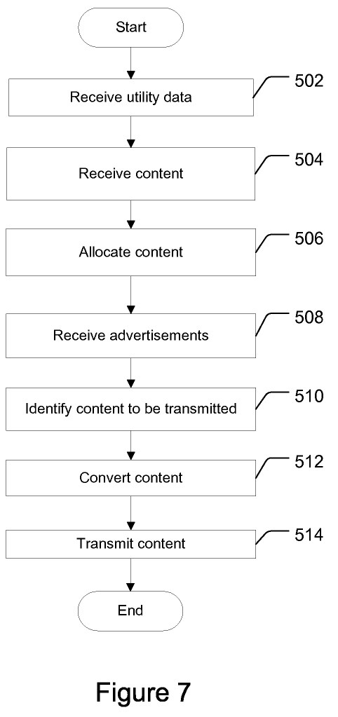

FIG. 7 shows a flow chart of the display manager application 500, which may be executed by the content server 208. The display manager application 500 manages content uploads and distribution. At step 502, utility data may be received from a utility data provider. Various data records may be associated with different members. Accordingly, the display manager application may store the utility data in association with the associated member (e.g., such as in the member's private content directory 300 in or in a database wherein the utility data is associated with the member's customer number or address).

At step 504, content is received from members, authorized users, third parties (e.g., alerts, messages, feeds). For example, test messages, fax messages, email messages and voice messages may be uploaded from one or more service providers and stored (if appropriate) in the appropriate members' private content directory 300 or a public directory. As another example, images, such as scenic landscapes or artworks, may be uploaded from a service provider. As still another example, an authorized user may upload content to a given member's private content directory 300. For example, a subscribing member may invite a relative to upload digital photos, such as family photos, or enable friends or relatives to send messages, video clips or photos from mobile phones, (i.e. “I found this shirt I thought that you would like. Take a look.”).

At step 506, the received content is allocated. More specifically, the server 208 determines whether (and where) to store the content on the server 208 (e.g., in one or more members' private content directories 300 or a public directory) and/or whether to substantially immediately distribute the received content to member photo frames 100 (and to which member's photo frames). Thus, photos and other generally static content may be stored while live video feeds, alerts, and other generally dynamic content may distributed more immediately. The display manager may determine where (or whether) to store the received information based, in part, on information from the member received via the user interface application 400.

At step 508, advertisements may be uploaded to the content server 208 and stored in the ad directory 303. In some embodiments, the advertising manager application 305 that may be resident on the server 208 selects advertisements to be communicated to the photo frames 100 of the members. In other embodiments, the advertising manager application 305 may be remote from the content server 208, receive member information from the content server 208 (or elsewhere) sufficient for selecting advertisements, and transmit advertisements suitable for display by the photo frames 100 via the internet directly to the photo frames 100 (not through the content server 208). In such an embodiment, software embedded in the photo frames 100 then controls the display of the advertisements (e.g., as part of a display).

At step 510, the display manager application 500 may process the member content configurations set by each member via the user interface application 400 to identify the content to be transmitted to each photo frame 100. In one embodiment such configurations may determine what content within a given member's private content directory 300, what content in public sub-directories, what content feeds (e.g., live video feeds, audio feeds, etc.), what other member's private content, and what other content is to be transmitted to the member's digital photo frame 100 and when. In another embodiment, such as for a digital photo frame 100 having buttons that allows a member to select among configurations, multiple groups of content and associated configurations may be downloaded to the digital photo frame 100.

For some content, at step 512 the process may include converting the identified content to a format that is suitable for display by the targeted photo frame 100.

At step 514, various content is transmitted to the digital photo frames 100 (or the server directory that the photo frame accesses) of the members in accordance with their selected content and configurations. In addition, configuration information may also be transmitted to the digital photo frames 100. For example, if a digital photo frame 100 has partitioning capability, information of the size and content to be displayed in each partition may also be transmitted to the photo frames 100. If the photo frames 100 have minimal configuration capabilities, the content server 208 may configure various content (e.g., by creating a new digital image that includes multiple photos in multiple partitions) before transmitting the content. The content may be replaced periodically with updated or different content.

While the above example embodiment pushes content to the digital photo frames, in other embodiments the photo frames (or an ancillary device at the photo frame location) request the content as necessary such as according to received configuration information supplied by the user or the content server. With respect to utility data that can be presented to the user, the consumer can create their own price signal (e.g., an indicator) based on the current price per hour that can be presented by the photo frames, an LED, or another device. If the cost per hour is below a threshold the device glows green. If the cost is in excess of another threshold then the device glows red. This allows for less cogitation on the part of the citizen. For example, a consumer can tell the family members “If that thing is red please turn off or unplug any thing in the house that you can and don't run the drier.”

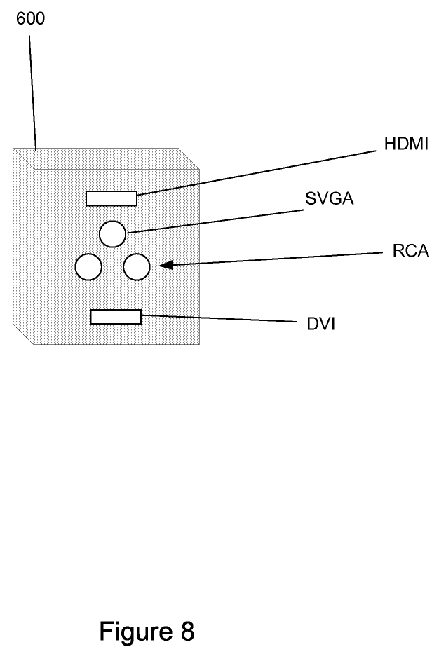

Instead of using a digital photo frame as the displaying device, a television could be used as part of the display device. FIG. 8 illustrates a multi-media power line modem device 600 that includes a first port connected to a power line modem (configured to communicate over an internal low voltage power line). The first port may include a plug configured to plug into a conventional electric wall socket. In addition, the device 600 may include one or more output ports, each of which is configured to deliver audio-video content via a different standard. As shown in this example, the device 600 includes an HDMI (High Definition Multimedia Interface) connector, an SVGA (Super Video Graphics Array) connector, a pair of RCA connectors, and a DVI (Digital Visual Interface) connector. Internally the device 600 may include circuitry and software for converting internet based packets to the format of the output ports. In addition, the device 600 may include the memory 108 and processor 110 described in FIG. 1 and perform the functions described for the photo frame 100 above (control display) except that the television provides the display 106 function. This device 600 also could connect to other power line modems connected to the internal power lines 226 of the customer premises 212 without the need to communicate over the internet. For example, the device 600 may directly communicate with a video cam at the user's front door (that is also connected to the internal power lines 226 via a power line modem) to display people arriving at the front door on the user's television.

The various applications described herein may be implemented via suitable program code. The names of the various applications described herein (e.g., user services application, display manager application, etc.) have been used for convenience of explanation of the functions that may be provided by some embodiments of the present invention. As will be evident to those skilled in the art, functions of the present invention may be implemented in numerous variations and the present invention is not limited to a particular implementation.

It is to be understood that the foregoing illustrative embodiments have been provided merely for the purpose of explanation and are in no way to be construed as limiting of the invention. Words used herein are words of description and illustration, rather than words of limitation. In addition, the advantages and objectives described herein may not be realized by each and every embodiment practicing the present invention. Further, although the invention has been described herein with reference to particular structure, steps and/or embodiments, the invention is not intended to be limited to the particulars disclosed herein. Rather, the invention extends to all functionally equivalent structures, methods and uses, such as are within the scope of the appended claims. Those skilled in the art, having the benefit of the teachings of this specification, may affect numerous modifications thereto and changes may be made without departing from the scope and spirit of the invention.

What is claimed is:

1. A method of providing content to a digital photo frame disposed in a customer premises, comprising:
storing a plurality of photos on a server;
transmitting the plurality of photos via the Internet to the digital photo frame for display;
receiving power usage data of the customer premises; and
transmitting data of the power usage of the customer premises to the digital photo frame for display.

2. The method according to claim 1, wherein the digital photo frame is configured to communicate over a low voltage power line.

3. The method according to claim 1, wherein the data of the power usage comprises information of the cost of the power consumed by the customer premises over a preceding time frame.

4. The method according to claim 1, further comprising transmitting internet radio content to the digital photo frame.

5. The method according to claim 1, further comprising transmitting advertisements to the digital photo frame for display.

6. The method according to claim 1, further comprising receiving the plurality of photos from a plurality of consumers.

7. The method according to claim 1, further comprising:
receiving a plurality of content; and
converting the content from a first format to a second format suitable for display by the photo frame.

8. The method according to claim 1, further comprising:
storing data of a reminder; and
transmitting information of the reminder to the digital photo frame for presentation at a time based on the data of the reminder.

9. The method according to claim 1, further comprising transmitting information of a safety alert to the digital photo frame.

10. The method according to claim 1, further comprising transmitting content of an email to the digital photo frame.

11. The method according to claim 1, further comprising transmitting content of a fax to the digital photo frame.

12. The method according to claim 1, further comprising transmitting content of a text message to the digital photo frame.

13. The method according to claim 1, wherein the plurality of photos are transmitted over a communication path that includes a power line.

14. A method of distributing content to a plurality of digital photo frames disposed in a plurality of customer premises, comprising:
associating, in a memory, a member with each of the plurality of digital photo frames;
receiving content from each of a plurality of members;
storing the received content in a memory; and
for each member, transmitting the content received from the member to the photo frame of the member.

15. The method according to claim 14, further comprising allocating at least some of the received content as private content and some of the received content as public content.

16. The method according to claim 14, further comprising:
receiving content configuration data from a plurality of members;
storing the content configuration data in memory; and
for each member, selecting content for said transmitting in accordance with the member's content configuration data.

17. The method according to claim 14, further comprising transmitting utility data for each of the customer premises to the photo frame of the respective customer premises.

18. The method according to claim 14, further comprising transmitting advertisements to the plurality of the digital photo frames for display.

19. The method according to claim 14, further comprising converting at least some of the received content from a first format to a second format suitable for display by a photo frame before said transmitting.

20. The method according to claim 14, further comprising:
storing reminder data for one or more members; and
transmitting information of a reminder to the digital photo frames of the one or more members for presentation at a time based on the respective reminder data.

21. The method according to claim 14, further comprising transmitting content of an email to the digital photo frames of one or more members.

22. A method of distributing content to a plurality of digital photo frames disposed in a plurality of customer premises, comprising:
receiving a plurality of content;
storing the plurality of content in a memory;
converting at least some of the plurality of content from a first format to a second format suitable for display by a digital photo frame;
transmitting at least some of the plurality of content via the Internet to each of the plurality of digital photo frames for display.

23. The method according to claim 21, further comprising:
storing in a memory information of a user in association with each of the plurality of digital photo frames;
storing content configuration information in a memory for each user;
selecting content for said transmitting based on the content configuration information of the user associated with each digital photo frame.
